(19) United States
(12) Patent Application Publication
(10) Pub. No.: US 2004/0048003 A1
(43) Pub. Date: Mar. 11, 2004

(54) Method for coating a substrate having holes

(76) Inventors: Andre Jeutter, Grafenau (DE); Werner Stamm, Muelheim A.D. Ruhr (DE)

Correspondence Address: SIEMENS CORPORATION, INTELLECTUAL PROPERTY DEPT., 170 WOOD AVENUE SOUTH, ISELIN, NJ, 08830, US

(21) Appl. No.: 10/659,219

(22) Filed: Sep. 10, 2003

(30) Foreign Application Priority Data
Jan. 15, 2002 (EP) 02000875.1

(51) Int. Cl. B05D 3/00

(52) U.S. Cl. 427/555; 427/551; 427/140

(57) ABSTRACT

Prior art coating methods have the following drawback in that the dimensions of existing holes in the substrate are altered when coating them thereby limiting the function and effect of the hole and of the substrate. The inventive method for coating a substrate having holes makes it possible for holes to retain their dimensions due to the fact that they are protected by a plug.

The invention relates to a method for coating a substrate containing holes.

Film-cooled substrates in the form of turbine blades have holes e.g. for the passage of coolant, further layers such as so-called MCrAlY coatings or heat insulating layers being applied to the metallic substrate of the turbine blades. The film cooling bores in the substrate must not be geometrically impaired thereby because this would cause the surface temperature of the turbine blade to increase, resulting in a reduction in the turbine blade lifetime.

Electrochemical processes, for example, wherein the layers are deposited on the substrate at low temperatures (e.g. 50° C.) are used for coating the metallic substrate as part of turbine blade manufacturing. However, in the case of a coating applied using a method of this kind, chipping and concentration inhomogeneities occur in the near-surface region, which functionally impairs the coating. In the case of a MCrAlY coating, this results in a deterioration in the oxidation resistance and, in the case of application of a heat insulating layer, in reduced adhesion of the heat insulating layer.

The object of the invention is accordingly to specify a method whereby the geometry of a hole, specifically a film cooling hole, of a substrate is preserved when a coating is applied to the substrate and during subsequent treatment, and improved coherence of the coating is ensured.

This object is achieved by the method according to claim 1.

The method according to the invention for coating a substrate, preferably a turbine blade, containing holes provides for filling said holes, in an initial step, with a material or plug in such a way that they are externally covered and are thus subsequently protected from changes in their geometry. In a subsequent step, advantageous electrochemical or low-temperature application of at least one layer takes place. During coating, the plug protects the hole from being filled with material, as the plug is dimensionally stable at the coating process temperatures.

At least one layer requires surface irradiation during which the surface of the layer is advantageously partially fused. Surface irradiation causes the near-surface particles of the coating to be bonded to the substrate with homogenization of the element distribution, so that the function of the layer as oxidation protection or adhesive layer is maintained even under extreme service conditions. This simultaneously prevents any modification of the hole structure by the process which affects only the surface.

Advantageous developments of the method according to claim 1 are listed in the subclaims.

The plug is, for example, soft and easily insertable into the hole at a temperature which is higher than that of the low-temperature application process. With the low-temperature application process, the plug can be easily removed by heating. The plug is preferably made of wax. The plug can also be made of graphite which can be easily removed by oxidation on exposure to air.

A particular advantage of the method according to the invention is that during surface treatment the vaporizable material can be evaporated, i.e. removed, from the hole.

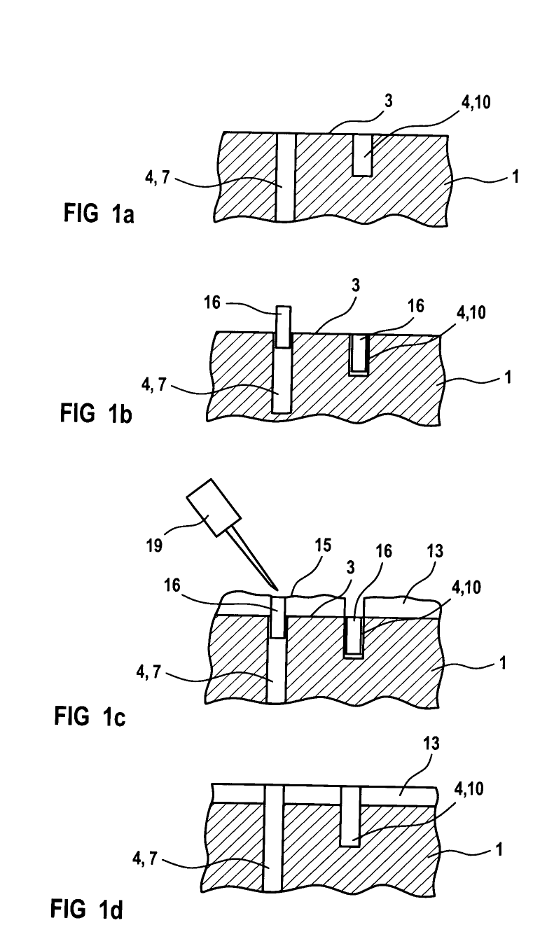

Individual steps of the method according to the invention are shown schematically in FIGS. 1a to 1d as an exemplary embodiment.

FIG. 1a shows a substrate 1 which constitutes part of a turbine blade, specifically a gas turbine blade.

The substrate 1 has at least one hole 4. The hole 4, of which there is at least one, can be a through-hole 7 or a blind hole 10. The through-hole 7 is used, for example, as a film cooling hole, e.g. air flowing through said film cooling hole 7 from inside to outside during operation of the turbine blade 1 and protecting the substrate 1 from hot gases on the surface.

The substrate 1 has a surface 3.

In the first step of the method according to the invention, a plug 16 is inserted in the hole 4 in the near-surface region (FIG. 1b). The plug 16 can seal the hole flush with the surface or project above the surface 3. The metal or ceramic substrate 1 can also already have a coating onto which another layer 13 (FIG. 1c) is applied.

Wax, Loctite adhesive or other materials that are dimensionally heat-resistant at the coating temperature of the layer 13, but can preferably be evaporated, for example, at a higher temperature, are used as the material for the plug 16.

The wax is forced into the hole 4 in solid form or heated so that it flows into the hole 4 and forms a plug 16.

In a further step (FIG. 1c), the e.g. metallic layer 13, of which there is at least one, is applied to the surface 3 of the substrate 1 itself or to the surface of a layer already present on the substrate 1. This can be, for example, a so-called MCrAlY coating, “M” standing for an iron, cobalt or nickel element. A coating of this kind is used to protect the substrate 1 from oxidation.

This layer 13 is applied to the substrate 1 by means of a low-temperature coating process, e.g. an electrochemical process. Electrochemical deposition processes take place, for example, at a temperature below 250° C., specifically below 100° C., preferably at approximately 50° C.

A ceramic, e.g. a heat insulating layer, can also be applied to the surface 3 of the substrate 1.

Because of the low temperatures, there is little or no stress between layer and substrate, as any difference in expansion coefficients or different substrate and layer temperatures can produce no or only slight stresses during cooling.

If the plug 16 projects above the surface 3 of the substrate, no material is deposited on the projecting part. Even if the plug 16 does not project above the surface 3, but is flush with the surface 3, there is likewise no material deposition in the region of the plug 16 because little or no adhesion of the material of the layer 13 on the plug 16, for example, is possible.

The layer 13 requires post-treatment by irradiation of the surface 15 (FIG. 1c) which improves the adhesion of particles of the layer 13 and ensures homogenization in the near-surface region, the layer 13 being fused, for example, at and/or under the surface 15. This can be performed by laser treatment or e.g. pulsed electron irradiation.

This ensures an even distribution of the elements of deposited CrAly particles.

Other methods are conceivable here.

For surface irradiation using a surface treatment equipment 19, the temperature can be selected, for example, such that the plug 16 is evaporated. However, means of evaporating the plug 16 in an additional heat treatment step or simply removing it mechanically can also be provided.

FIG. 1d shows a substrate 1 with a layer 13, the geometry of the hole 4 being maintained even after coating.

If the layer 13 is a MCrAlY coating, an additional ceramic heat insulating layer can also be applied in the same manner.

The method can be used e.g. for refurbishment, i.e. for re-coating a substrate that has already been used.

1. Method for coating a substrates (1) having at least one hole (4),
wherein, in a first step, the hole (4), of which there is at least one, is covered by a plug (16),
in a further step, at least one layer (13) is applied to a surface (3) of the substrate (1) and
a low-temperature coating process being used as the method of applying the layer (13),
in a further step, irradiation of a surface (15) of the layer (13), of which there is at least one, taking place so as to provide better adhesion and homogenization of particles in the near-surface region of the layer (13).

2. Method according to claim 1, characterized in that the substrate (1) is a turbine blade.

3. Method according to claim 1, characterized in that during irradiation a region below the surface (15) of the layer (13) is at least partially fused.

4. Method according to claim 1, characterized in that an electrochemical method for depositing layers is used as the low-temperature coating process.

5. Method according to claim 1, characterized in that the temperature for the low-temperature coating process is below 250° C., specifically below 100° C.

6. Method according to claim 1, characterized in that irradiation of the surface (15) is performed using pulsed electron irradiation.

7. Method according to claim 1, characterized in that irradiation of the surface (15) is performed using a laser treatment.

8. Method according to claim 1, characterized in that during or at the end of irradiation of the surface (15), the plug (16) is removed from the near-surface region of the hole (4).

9. Method according to claim 8, characterized in that the plug (16) is removed by evaporation.

10. Method according to claim 1, characterized in that the layer (13) is a ceramic, specifically a ceramic heat insulating layer, or a metal, specifically a MCrAly coating (M═Fe, Co, Ni).

11. Method according to claim 1, characterized in that the hole (4), of which there is at least one, is a film cooling hole or an impingement cooling hole.

12. Method according to claim 1 characterized in that the plug (16) is of a wax-like material.
